(19) United States
(12) Patent Application Publication
(10) Pub. No.: US 2026/0184512 A1
(43) Pub. Date: Jul. 2, 2026

(54) AUTOMATED ITEM-HANDLING AND LOADING SYSTEM

(71) Applicant: Daifuku Co., Ltd., Osaka (JP)

(72) Inventors: Kiyoshi SHIKI, Osaka (JP); Takeshi NISHIGAKI, Osaka (JP); Takao MUKO, Osaka (JP); Jun HAMAGUCHI, Osaka (JP); Takaya UEMOTO, Tokyo (JP); Masayuki IZUTSU, Osaka-shi (JP)

(21) Appl. No.: 19/438,492

(22) Filed: Dec. 31, 2025

Related U.S. Application Data
(60) Provisional application No. 63/741,283, filed on Jan. 2, 2025.

(51) Int. Cl. B65G 1/137

(52) U.S. Cl. CPC B65G 1/1376

(57) ABSTRACT

Examples described herein include item-handling systems and related methods for sorting items, such as baggage, parcels, and packages, being moved along a conveyor system. An example system includes a sensor operable to obtain item information associated with the items being transported along the conveyor system. A controller in communication with the sensor is operable to identify a target item from the items being transported based on the information captured by the sensor. Once a target item has been identified, the target item is diverted from the conveyor system to a discharge conveyor, where the item is transported to a loading area and loaded onto a loading container via an automated loading device. In some examples, untargeted items may remain on the conveyor system until they reach a second loading area where the untargeted items may be manually loaded onto a loading container.

### CROSS-REFERENCE TO RELATED APPLICATION(S)

This application claims priority to U.S. Provisional Application No. 63/741,283 filed Jan. 2, 2025, the disclosure of which is incorporated herein by reference, in its entirety, for any purpose.

### TECHNICAL FIELD

The present disclosure relates generally to the field of item-handling systems, and in particular, to such handling systems designed to identify, sort, and load items into corresponding containers.

### BACKGROUND

Some conventional item-handling systems, such as for handling baggage, parcels, packages, and/or other suitable items, primarily rely on human workers to identify and remove items as the items pass by on conveyor systems. The items may then be manually loaded onto corresponding containers based on tags or other identification information associated with the item. Some conventional item-handling systems may also include automated components, such as robots and other suitable loading devices, to aid in identifying and sorting items. For example, in some automated item-handling systems, sensors or other suitable data readers may be used to capture item information from item tags (e.g., barcodes, RFID tags, or other suitable devices) associated with the item, where the captured item information may then be used to identify and sort the item based on the item information.

These conventional designs have several inefficiencies and limitations. For example, relying on a human work force results in an overall slower sorting process. In addition, the process is prone to human error due to misidentified packages and results in a significant risk of worker injury from moving heavy items and working near moving components and related machinery. While automated designs may resolve some of these deficiencies, conventional automated systems tend to be inaccurate and inefficient when handling large item volumes. For example, when items bunch together, item tags are obscured and cloud the system's ability to capture and read data from the item tags. These issues result in misread or unread items, thereby leading to misdirected items and increased item-processing times. In addition, conventional automated systems tend to be insufficiently flexible for handling non-uniform items or items with unconventional sizes and dimensions. These disadvantages make conventional automated systems generally unsuitable and inefficient for environments with large processing volumes, such as airport baggage during holidays and other peak travel seasons. In addition, airport baggage typically includes irregular items such as soft-sided bags and totes that may be challenging to properly identify and handle by conventional systems.

### SUMMARY

Examples of systems are described herein. An example system may include a conveyor system configured to receive and transport one or more items thereon and a sensor operable to obtain item information from each item of the one or more items. The conveyor system may include an inlet conveyor configured to receive and transport the one or more items along an inlet pathway, and a primary conveyor that receives the items from the inlet conveyor and transports the items along a closed pathway for further processing. In some example systems, the items may include airport baggage, and the item information may include one or more of a baggage destination, a baggage type, a baggage weight, a baggage priority status, and/or a baggage size.

The example system includes a controller in communication with the sensor, where the controller is configured to receive the item information from the sensor for each item. In one example, the controller and sensor may be integrated into one unitary component, but in other embodiments, the controller and sensor may be standalone components in operative communication with one another. Based on the item information for each item, the controller (and/or sensor) is operable to identify a target item from the one or more items. Once the target item has been identified, a discharge system diverts the target item from the conveyor system to a discharge conveyor at a first loading area, while allowing untargeted items to bypass the first loading area until the untargeted items reach a second loading area. At the first loading area, an automated loading device obtains the target item from the discharge conveyor based on loading instructions received from a loading algorithm, where the automated loading device is configured to load the target item onto a loading container based on the loading instructions. In some examples, the second loading area may be a manual loading area, where the manual loading area is positioned adjacent a pathway of the conveyor system to facilitate for a human worker access to the untargeted items on the conveyor for manual loading.

In some example systems, each item further includes a unique item tag, such as an optical code and/or an RFID tag, associated therewith, the item tag storing the item information. In some example systems, the sensor may include an optical code operable to capture the optical code from the item to obtain the item information. In other example systems, the sensor may include an RFID reader operable to read the RFID tag associated with the item to obtain the item information.

In some example systems, the sensor is an image sensor, such as a camera or other imaging device, operable to capture image data of each item of the one or more items. In such systems, the controller receives the image data from the sensor and identifies the target item based on the image data. In some example systems, the controller compares one or more physical characteristics of the item to a corresponding threshold parameter for each of the one or more physical characteristics to identify the item. In other example systems, other image analysis techniques may be used.

In some example systems, the discharge system includes one or more diversion arms, where each diversion arm is configured to contact and move the target item from the conveyor system toward the discharge conveyor. In some example systems, the controller is configured to generate and transmit discharge instructions to the discharge system based on the item information, where the discharge instructions are based on compatibility of the target item with the automated loading device and/or the loading container.

Some example systems include an image sensor having a field-of-view overlaying at least a portion of the discharge conveyor, where the image sensor is operable to capture image data from the target item while the target item is on the discharge conveyor, wherein the image data captures a position and/or orientation of the target item relative to the discharge conveyor. Some example systems include a centering device operable to reposition the target item on the discharge conveyor based on the position and/or orientation of the target item relative to the discharge conveyor captured in the image data.

In some example systems, a scale is used to weigh the target item prior to the automated loading device obtaining the target item from the discharge conveyor for loading onto the loading container.

Some example systems may include an image sensor with a field-of-view overlaying at least a portion of the loading container, where the image sensor is operable to capture image data of the loading container, the image data capturing capacity information of the loading container. Some example systems may further include a storage conveyor and a second discharge system, where the second discharge system is operable to divert the target item from the discharge conveyor onto the storage conveyor for storage thereon. In such systems, the second discharge conveyor diverts the target item from the discharge conveyor based on the capacity information of the loading container. In some example systems, the storage conveyor may be controlled by the controller, the second discharge system, and/or the automated loading device to cause the storage conveyor to move the target item back onto the discharge conveyor for loading onto the loading container based on the capacity information of the loading container.

Some example systems may include a second discharge system operable to divert the target item from the discharge conveyor back to the conveyor system. In some examples, a return conveyor receives the diverted target item from the discharge conveyor and transfers the item back to the conveyor system.

### BRIEF DESCRIPTION OF THE DRAWINGS

The drawings depict only several examples in accordance with the disclosure and are therefore not to be considered limiting in scope. Example embodiments will be described with additional specificity and detail through use of the accompanying drawings, in which:

FIG. 1 is a schematic diagram of an item-handling system including a discharge system for diverting items from a conveyor system for loading onto a loading container according to some examples.

FIG. 2 is a schematic diagram of an item-handling system including a discharge system for diverting items in an automated loading area toward a temporary storage conveyor or back onto the conveyor system for further processing according to some examples.

FIG. 3 is a schematic diagram of an item-handling system designed for sorting and loading pre-identified items at an automated loading area or a manual loading area according to some examples.

FIG. 4 is a schematic diagram of another item-handling system including a pair of first discharge systems for diverting items from a conveyor system to discharge conveyors for loading onto a loading container, the item-handling system including a pair of second discharge systems for diverting items from the discharge conveyors onto storage conveyors for temporary storage or back onto the conveyor system for further processing according to some examples.

FIG. 5 is a schematic diagram of an item-handling system including multiple independent discharge systems each operable for diverting items into an automated loading area for loading onto a corresponding loading container, the system further including a return conveyor for diverting items back onto a conveyor system for further processing according to some examples.

FIG. 6 is a schematic diagram of another item-handling system including multiple independent discharge systems each operable for diverting items into an automated loading area for loading onto a corresponding loading container, the system further including a return conveyor for diverting items back onto a conveyor system for handling according to some examples.

FIG. 7 is a schematic diagram of an item-handling system including multiple independent discharge systems each operable for diverting items from a conveyor system to one of multiple automated loading areas for loading onto a loading container, the system further including a return conveyor in at least one of the automated loading areas for diverting items back onto another conveyor for further handling according to some examples.

FIG. 8 is a schematic diagram of an item-handling system including multiple independent discharge systems each operable for diverting items from a conveyor system to one of multiple automated loading areas for loading onto a loading container, the system further including a return conveyor in each of the automated loading areas for diverting items back onto another conveyor for further handling according to some examples.

### DETAILED DESCRIPTION

With reference to the drawings, this section describes various embodiments of an item-handling system for transporting and sorting items and its detailed construction and operation. Throughout the specification, reference to “one embodiment,” “an embodiment,” or “some embodiments” means that a described feature, structure, or characteristic may be included in at least one embodiment of an item-handling system. Thus, appearances of the phrases “in one embodiment,” “in an embodiment,” or “in some embodiments” in various places throughout this specification are not necessarily all referring to the same embodiment.

Certain details are set forth below to provide a sufficient understanding of embodiments of the disclosure. However, it will be clear to one skilled in the art that embodiments of the disclosure may be practiced without some of these particular details. Moreover, the embodiments of the present disclosure described herein are provided by way of example and should not be used to limit the scope to these particular embodiments. In addition, the described components, features, structures, and characteristics may be combined in any suitable manner in one or more embodiments. In other instances, well-known materials, components, processes, controller components, and/or software have not been described or shown in detail in order to avoid unnecessarily obscuring the embodiments.

The present disclosure generally relates to item-handling systems for transporting, identifying, and sorting items. In some embodiments, the items being handled may include baggage, parcels, containers, or the like. For convenience, the drawings and the following discussion focuses on example systems and methods where the items are airport baggage, including hard-shell suitcases, soft-shell suitcases, bags, totes, and other similar items that may be used for travel. It should be understood, however, that in other embodiments, the item-handling system may be used in conjunction with other suitable items without departing from the principles of the disclosed subject matter. Accordingly, while the discussion focuses on airport baggage, these examples are not intended to be limiting. The same concepts disclosed herein may apply equally to item-handling systems used in other environments.

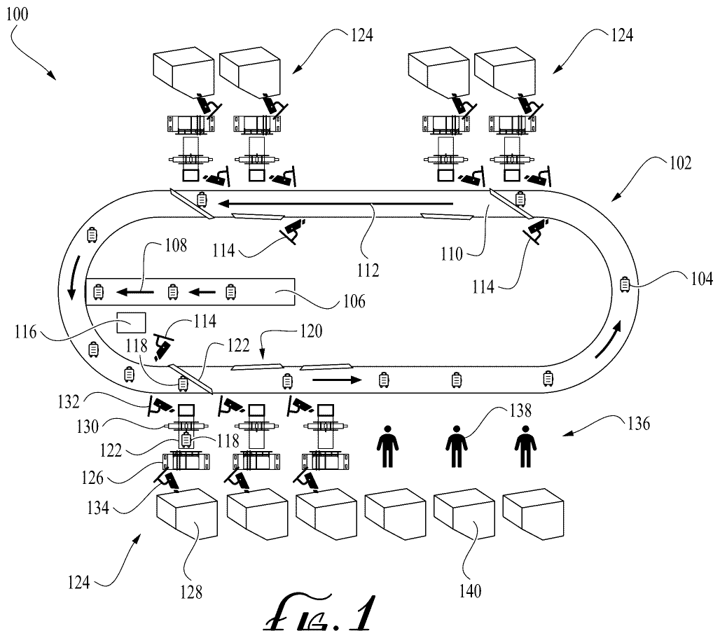

As is described in further detail below with collective reference to FIGS. 1-8, the item-handling systems and related method of operation disclosed herein include a conveyor system (which may include one or more conveyors) that receives and transports items along a pathway. In some examples, the conveyor system may include a carousel conveyor with a pathway that may be a closed route or loop. As the items are transported along the pathway of the conveyor system, a sensor (e.g., a camera, an optical code reader, an RFID reader, or other suitable electronic device) may obtain item information from each item, where the item information may be subsequently used to identify target items on the conveyor system for discharge and subsequent loading onto specific loading containers. In some examples, the item information may include a baggage destination, type, weight, priority status, and/or dimension. Based on the item information, a controller (which may be integrated as part of the sensor or may instead be a standalone component) identifies one or more target items on the conveyor system. Once the target item(s) has been identified, a discharge system in communication with the controller diverts the target item from the conveyor system onto a discharge conveyor at a first loading area, while allowing the other untargeted items to bypass the first loading area. Those untargeted items may continue traveling on the conveyor system until they reach a second loading area for further handling.

At the first loading area, an automated loading device obtains the target item from the discharge conveyor and loads the target item onto a loading container based on loading instructions that are generated, at least in part, from the item information. In one example, the item information includes baggage destination information to ensure that items being loaded at the first loading area are placed onto a specific loading container headed to the baggage destination. In some examples, the untargeted items that travel to the second loading area are manually loaded by human workers onto a loading container based on the item information to ensure that the manually loaded items are also directed to the proper destination based on the item information. The following disclosure provides additional details of these and other example embodiments with reference to the figures.

FIG. 1 is a schematic diagram of an item-handling system 100 for identifying and sorting one or more items 104 transported on a conveyor system 102 in accordance with some example embodiments. With reference to FIG. 1, the item-handling system 100 includes a conveyor system 102 configured to receive and transport the items 104 thereon. As noted previously, the items 104 may be airport baggage (as in the embodiments described and illustrated herein) or other items such as containers, parcels, packages, or any other suitable items. In one embodiment, the conveyor system 102 includes an inlet conveyor 106 that receives and transports the items 104 along an inlet pathway 108 toward a primary conveyor 110. In some examples, the inlet conveyor 106 may be independent controllable relative to the primary conveyor 110 to adjust spacing between items 104 as needed prior to transferring the items 104 onto the primary conveyor 110. The primary conveyor 110 receives and transports the items 104 along a pathway 112 for further processing as further described in detail below. The primary conveyor 110 may be any suitable conveyor such as a flat-type carousel conveyor with a closed pathway 112 in the form of a loop as illustrated in FIG. 1. In other examples, the primary conveyor 110 may have other suitable configurations for the pathway 112. The conveyors 106, 110 may be any suitable conveying elements, such as belt conveyors, roller conveyors, chain conveyors, and/or pneumatic conveyors, operable to carry and transport items 104 thereon along their respective pathways 108, 112.

The item-handling system 100 further includes one or more sensors 114 arranged relative to the primary conveyor 110, where the sensors 114 are operable to obtain item information from each item 104 as the item 104 moves along the pathway 112. In an example where the items 104 are airport baggage, the item information obtained by the sensors 114 may include a baggage destination (e.g., a final destination for the passenger to whom the baggage belongs), a baggage type (e.g., a hard-shell suitcase, a soft-shell suitcase, a tote, etc.), a baggage weight, a baggage priority status, and/or baggage exterior dimensions. The sensors 114 may be any suitable data reading device operable to capture item information from the items 104 as they move along the conveyor system 102. In some embodiments, the type of sensor 114 implemented in the item-handling system 100 may depend on the unique item tag associated with the item 104. In some embodiments, the primary conveyor 110 may be a closed loop conveyor as noted previously to provide the sensors 114 additional opportunities to capture item information from the items 104 that may have been missed previously, such as due to obstructions or misreads.

For example, in one embodiment, the item information may be encoded (or otherwise stored) onto a unique optical code that is associated with each corresponding item 104. For example, each item (e.g., baggage) 104 may include a printed label adhered thereto where the optical code is printed onto the label and visible to the sensor 114. In such embodiments, the sensors 114 may be optical code readers each with a field-of-view extending over the pathway 112 of the primary conveyor 110 to allow the sensors 114 to capture the optical code from the items 104 as they move along the pathway 112. In another example, the item information may be stored in a unique RFID tag associated with each corresponding item 104, where the sensors 114 are RFID readers operable to read the RFID tags as the items 104 move along the primary conveyor 110. In yet another example, the sensors 114 may be image sensors (such as cameras or other devices capable of capturing images) operable to capture image data of each item 104 as it moves along the primary conveyor 110. The image data may thereafter be processed to identify the items 104. For example, the image sensor 114 (and/or controller 116) may be configured to compare one or more physical characteristics of the item 104 to a corresponding threshold parameter for each of the one or more physical characteristics to identify the item 104 based on the one or more physical characteristics. In other examples, a combination of any of the above sensors 114 may be used. For example, some items 104 may have RFID tags and others optical codes, and the item-handling system 100 may include a combination of optical code readers and RFID readers for capturing the item information.

Once the item information has been obtained, a controller 116 in communication with the sensors 114 receives the item information. The controller 116 may include one or more processor(s) and related circuitry, computer-readable media (e.g., read only memory (ROM), random access memory (RAM), solid state drive (SSD), secure digital card (SD card), and the like), and/or other computing system components for allowing the controller 116 to process the item information captured by the sensors 114 and identify one or more target items 118 from the plurality of items 104 moving on the conveyor system 102 based on the item information. For example, the controller 116 may include executable instructions stored in memory for running suitable decoding engines for decoding the unique optical codes associated with the items 104, or may include executable instructions stored in memory for running RFID reading engines for obtaining the item information from RFID tags, or may include image-analysis software and related executable instructions stored in memory for processing and analyzing the image data to identify the item 104. In some embodiments, controller 116 may be integrated into each corresponding sensor 114 to form a single unitary component. For example, the controller 116 may be part of the optical code reader, the RFID reader, the imager/camera, or other suitable sensor 114. In other embodiments, the controller 116 may instead be a separate, standalone component apart from the sensor 114 and coupled therewith such as by a wired or wireless connection.

In one embodiment, the item-handling system 100 further includes one or more discharge systems 120 positioned adjacent the pathway 112 of the primary conveyor 110, where the discharge system 120 is in communication with the controller 116 (and/or the sensor 114). The discharge system 120 may include any suitable mechanism capable of diverting the target item(s) 118 from the primary conveyor 110 onto a different path as further described below. For example, in one configuration, the discharge system 120 includes one or more movable diversion arms 122 designed to push or divert (e.g., physically contact) the target item(s) 118 from the primary conveyor 110. The diversion arms 122 of the discharge system 120 may move across at least a portion of the primary conveyor 110 to contact the target item(s) 118 and divert them away from the primary conveyor 110 of the conveyor system 102. The diversion action of the target item(s) 118 is based on the item information as captured by the sensors 114 and the discharge instructions from the controller 116. In other examples, the discharge systems 120 may include any mechanical pusher mechanism that pushes the target item(s) 118 perpendicularly to the side of the primary conveyor 110 onto a different path, and/or may include a robot that grasps the target item(s) 118 from the primary conveyor 110 and moves them onto a different path, and/or may include controllable roller mechanisms onto which the target item(s) move, where the roller mechanisms are operable to redirect the target item(s) 118 along a different pathway relative to the primary conveyor 110.

In one example, the discharge system 120 diverts the target item 118 from the primary conveyor 110 onto a discharge conveyor 122 disposed at a first (automated) loading area 124 for further processing as described in further detail below. Any untargeted items 104 on the primary conveyor 110 bypass the discharge system 120 and the automated loading area 124 until those items reach a second (manual) loading area 136. As illustrated, the item-handling system 100 may include multiple automated loading areas 124, where each corresponding area 124 may be associated with a different destination for passenger baggage. The item-handling system 100 may also include multiple manual loading areas 136 (though only one is illustrated in FIG. 1). At the manual loading area 136, the untargeted items 104 may be manually processed and loaded as further described below. In one embodiment, the controller 116 generates and transmits discharge instructions for the discharge system 120 based on the item information and/or based on a compatibility of the target item 118 with an automated loading device 126 and/or the loading container 128 present at the automated loading area 124 as further described in detail below.

In some embodiments, the item-handling system 100 may omit the discharge systems 120 and instead rely on human workers to grab and move target item(s) 118 from the primary conveyor 110 and onto the discharge conveyor 122.

With reference to FIG. 1, at the automated loading area 124, the discharge conveyor 122 receives the target item 118 after it is diverted by the discharge system 120. In some embodiments, the item-handling system 100 includes an automated loading device 126 arranged at the automated loading area 124, where the automated loading device 126 is operable to obtain the target item 118 from the discharge conveyor 122. The automated loading device 126 may include one or more moveable arms, end effectors, and/oror other suitable mechanical and/or electromechanical elements operable for obtaining the target item 118, moving the target item 118 to another location, and releasing the target item 118 at the location. The automated loading device 126 may be fully automated and independently controllable based on stored loading algorithms that may include different loading instructions for handling different loading situations. In other embodiments, the automated loading device 126 may instead be semi-automated such that it may be at least partially controllable by a human operator and also controllable via stored loading algorithms and instructions.

As noted above, in some embodiments, the automated loading device 126 receives and executes loading instructions based on an applicable loading algorithm, where the loading instructions guide the specific actions of the automated loading device 126 based at least in part on the item information obtained from the target item 118. For example, the loading instructions may instruct the automated loading device 126 to pick up the target item 118 from the discharge conveyor 122 and load the item onto a loading container 128. The loading instructions and algorithms may be stored in memory associated with the automated loading device 126 or in any suitable database in communication with the automated loading device 126. In some embodiments, the controller 116 may be in operative communication with the automated loading device 126 (directly or through the suitable database), where the controller 116 transmits instructions to the automated loading device 126 to select and execute specific loading instructions. In other embodiments, the controller 116 may send the item information to the automated loading device 126 and the automated loading device 126 may select and execute specific loading instructions based on the loading algorithm and the item information associated with the item 104 being loaded.

In some embodiments, to ensure the target item 118 is properly positioned prior to handling by the automated loading device 126, the automated loading area 124 may further include a centering device 130 operable to reposition the target item 118 on the discharge conveyor 122 based on a beginning position and/or orientation (e.g., a position of a handle of a suitcase or casters of a rolling suitcase) of the target item 118 relative to the discharge conveyor 122. For example, the item-handling system 100 may include an image sensor 132 (e.g., a camera or other suitable device) having a field-of-view overlaying at least a portion of the discharge conveyor 122, such as an initial portion where the item 118 initially moves onto the discharge conveyor 122 from the primary conveyor 110. In this configuration, the image sensor 132 is operable to capture image data from the target item 118 while the target item 118 is on the discharge conveyor 122. From the image data, the image sensor 132 (or other suitable device in communication with the image sensor 132) may determine an initial position and/or orientation of the target item 118 relative to the discharge conveyor 122. If necessary, adjustment instructions may be communicated to the centering device 130 (such as via the image sensor 132 or other suitable device) to adjust the initial position of the target item 118 as needed to ensure it is in a proper handling position on the discharge conveyor 122 for subsequent handling by the automated loading device 126.

The centering device 130 may include a plurality of arms (not shown), end effectors, or other mechanical or electromechanical elements designed to move the target item 118 toward a target position on the discharge conveyor 122 for subsequent handling by the automated loading device 126. In other embodiments, the image sensor 132 may be omitted and the centering device 130 may instead act on all target item(s) 118 passing on the discharge conveyor 122 to ensure the target item(s) 118 are properly positioned prior to being handled by the automated loading device 126. In some embodiments, the image sensor 132 may be integrated as a component of the centering device 130.

In some embodiments, the item-handling system 100 may further include a second image sensor 134 (e.g., a camera or other suitable device) with a field-of-view overlaying at least a portion of the loading container 128, where the image sensor 134 captures image data of the loading container 128 to determine capacity information of the loading container 128. In other words, the image sensor 134 is capable of determining how full the loading container 128 is at any given point in time. In some embodiments, if the loading container 128 is at capacity, then instructions may be transmitted by the image sensor 134 (or other suitable device in communication with the image sensor 134) to the controller 116 and/or discharge system 120 to temporarily refrain from diverting additional target items 118 to the discharge conveyor 122. In some examples, stop instructions may also be transmitted to the discharge conveyor 122 to stop moving additional target items 118 toward the automated loading device 126. In some embodiments, the image sensor 134 may update (either directly or through the controller 116 or other suitable device) the loading algorithm and/or loading instructions to restrain the automated loading device 126 from attempting to load another target item 118 onto the loading container 128. Once the full loading container 128 has been moved and replaced with another loading container, the process of loading target items 118 may continue to load the target items 118 onto the new container 128.

As shown in FIG. 1, in some embodiments, the item-handling system 100 may include several automated loading areas 124, each of which having multiple independent loading lines arranged in the same fashion as described above. As noted previously, each automated loading area 124 may load target items 118 headed for different destinations to ensure the baggage is properly loaded to meet the customer at the destination airport. As noted previously, the item information for each target item 118 contains this destination information to ensure the target item 118 is loaded on the proper loading container 128 headed to the same destination as the baggage owner.

As noted previously, some of the items 104 that are not diverted by the discharge system 120 (e.g., the untargeted items) remain on the primary conveyor 110 and continue toward a second (manual) loading area 136. At the manual loading area 136, the untargeted items 104 may be manually loaded by a human worker 138 from the primary conveyor 110 onto a corresponding loading container 140 based on the item information (e.g., baggage destination) associated with the item 104. As noted previously, these untargeted items 104 may not be selected for automated loading for several reasons, such as baggage size, weight, destination, status, or for any other suitable reasons. Although only one manual loading area 136 is illustrated in FIG. 1, the item-handling system 100 may include several manual loading areas 136 positioned at various points along the pathway 112 of the primary conveyor 110 to expedite the baggage handling process and allow the human workers 138 to load baggage that was not diverted by the discharge system 120. In other embodiments, a discharge system (similar to discharge system 120) may divert the items 104 from the primary conveyor 110 toward the manual loading area 136 for manual loading by a human worker 138 as described above.

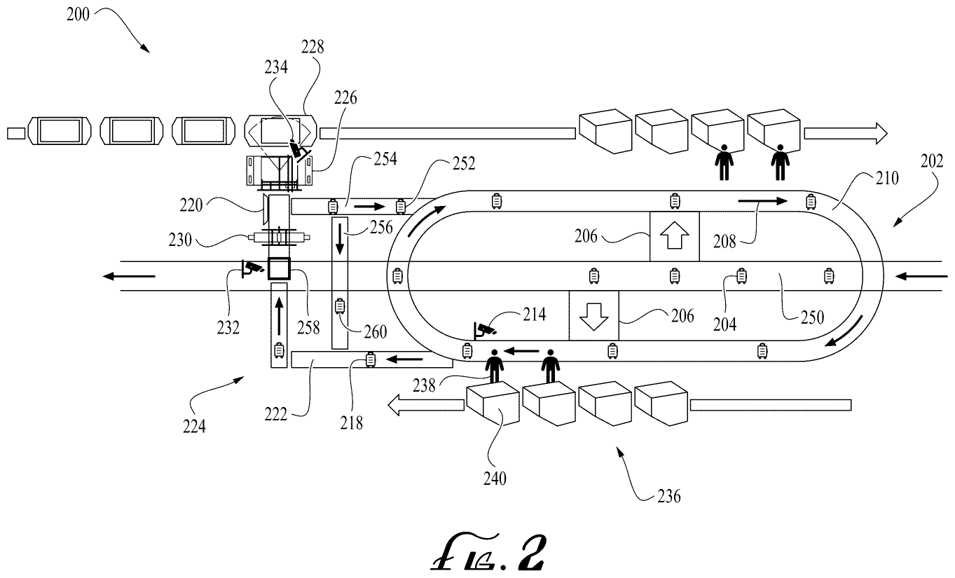

FIG. 2 is a schematic diagram of another example embodiment of an item-handling system 200 for sorting one or more items 204 transported on a conveyor system 202. With reference to FIG. 2, the item-handling system 200 may include some of the same or similar elements arranged and operating in the same or similar fashion as previously described with respect to the item-handling system 100 of FIG. 1. Accordingly, some features of the item-handling system 200 may be described briefly or otherwise omitted in the following description to avoid obscuring more pertinent features of the embodiment with the understanding that features described with reference to item-handling system 100 of FIG. 1 may also apply to item-handling system 200 of FIG. 2.

Briefly, the item-handling system 200 includes a conveyor system 202 configured to receive and transport one or more items 204 thereon. As the items 204 travel along the conveyor system 202, a sensor 214 (e.g., a camera, an optical code reader, an RFID reader, etc.) obtains item information to identify and determine one or more target item(s) 218 for diverting to the first (automated) loading area 224. At the loading area 224, the target item(s) 218 are transported on a discharge conveyor 222 to move the target item(s) 218 toward an automated loading device 226 operable to load the target item(s) 218 onto a loading container 228 in a substantially similar fashion as described previously with reference to item-handling system 100 of FIG. 1. As noted previously, these components of the item-handling system 200 are designed to operate in a similar fashion as described with reference to the previous example embodiment of the item-handling system 100. Accordingly, the prior disclosure relating to these and other like components is incorporated into the description of like components of item-handling system 200 of FIG. 2. The following provides additional information focusing on different aspects and functionalities of the item-handling system 200 of FIG. 2 as compared to the prior embodiment.

With reference to FIG. 2, the conveyor system 202 may include an infeed conveyor 250 that receives the items 204 for further processing. In some embodiments, the infeed conveyor 250 may be associated with a drop site where airport passengers drop off the items 204 (e.g., airport baggage) prior to boarding their respective flights. The conveyor system 202 further includes one or more inlet conveyors 206 in operable communication with the infeed conveyor 250, where the inlet conveyors 206 receive the one or more items 204 from the infeed conveyor 250 and transport them along a pathway 208 to a primary conveyor 210 in a similar fashion as described previously with reference to FIG. 1. The inlet conveyors 206 may be independently controllable relative to one another and the infeed conveyor 250 to adjust spacing between adjacent items 204 prior to the items 204 reaching the primary conveyor 210 for subsequent processing. In other embodiments, all conveyors in the item-handling system 200, including conveyors 206, 210, 222 may be independently driven to facilitate spacing between the items 204, 218 as needed for optimizing further processing and loading.

In some embodiments, the sensors 214 positioned adjacent the primary conveyor 210 may not be fully capable of identifying all target items 218 for automated loading. For example, in one embodiment, the sensor 214 may be useful for determining item spacing and detecting paired items (i.e., multiple items or baggage associated with the same traveler), but incapable (or at least not fully capable) of identifying item size, type, dimension, priority, etc. due to various reasons. For example, the item volume may be too large for efficient handling, or the sensor parameters and performance characteristics may not be sufficient to handle the identification task. To resolve this issue, the item-handling system 200 is configured to make these determinations at the automated loading area 224 as further described below.

With reference to FIG. 2, the automated loading area 224 includes an image sensor 232 (e.g., a camera or other suitable device) having a field a field-of-view overlaying at least a portion of the discharge conveyor 222. In this configuration, the image sensor 232 is operable to capture image data from the target item 218 while the target item 218 is on the discharge conveyor 222 to determine a position and/or orientation of the item 218 in a similar fashion as described previously with reference to image sensor 132. If necessary, a centering device 230 may adjust a position and/or orientation of the target item 218 as needed, based on the image data acquired by the image sensor 232 to ensure the item 218 is in proper position on the discharge conveyor 222 for subsequent handling. In some embodiments, the image sensor 232 may be further configured to capture image data for subsequent image analysis to obtain the item information (e.g., item type, size, priority status, etc.) from the image data. The item information is used to confirm that the target item 218 is appropriate for loading onto the loading container 228. In some embodiments, the image sensor 232 may communicate with a controller 216 (or other suitable device) for analyzing the image data and making this determination in a similar fashion as described previously with reference to the sensor 114 and controller 116 of FIG. 1. In other embodiments, an additional sensor (not shown) may be used in the automated loading area 224, such as an optical code reader and/or an RFID reader to obtain item information in a similar fashion as described previously with reference to sensors 114 of FIG. 1.

Once the target items 218 are confirmed as being appropriate for automated loading, the automated loading device 226 may obtain the item (after it has been properly positioned via the centering device 230) and load it onto the loading container 228 in a similar fashion as described previously. For any rejected items 252, a discharge system 220 (with features similar to discharge system 120 of FIG. 1) arranged in the automated loading area 224 may divert the rejected item 252 from the discharge conveyor 222 back onto a return conveyor 254, which transports the item 252 back onto the primary conveyor 210 for further processing. In some embodiments, the rejected item 252 may be transported by the primary conveyor 210 to a second (manual) loading area 236. At the manual loading area 236, human workers 238 may pull the item 252 off the primary conveyor 210 and manually load it onto a loading container 240 in a similar fashion as described previously. Items may be rejected at the automated loading area 224 due to incompatible size, type, dimensions, or for other suitable reasons.

In some embodiments, an image sensor 234 may be configured to determine a capacity status of the loading container 228 in a similar fashion as described previously. If the loading container 228 exceeds a threshold capacity at any given point, the item(s) 218 may be rejected for loading and instead diverted onto the return conveyor 254. In other embodiments, the item (e.g., storage item 260) may instead be sent to a storage conveyor 256 for temporary storage while the full loading container 228 is moved and replaced by a subsequent loading container 228 with available storage space for further loading. In some embodiments, the storage conveyor 256 may be in communication with the image sensor 234, the controller 216, the discharge system 220, and/or the automated loading device 226. Once a new loading container 228 is available to accept more target items 218, the image sensor 234, the controller 216, the discharge system 220, and/or the automated loading device 226 may send instructions to operate the storage conveyor 256 to call the target item 218 back from storage for subsequent loading onto the loading container 228. The return conveyor 254 may direct the temporarily stored item directly to the automated loading device 226 for loading or may direct the stored item back to any other point of the discharge conveyor 222 for subsequent loading.

In some embodiments, the rejected items 252 may be tagged and deemed unsuitable for automated loading. For example, the optical code associated with the item may be updated to ensure the rejected item 252 is marked for manual loading at the manual loading area 236 and prevent it from returning to the automated loading area 224. In such embodiments, the human workers 238 may have data readers or other suitable devices, such as augmented reality glasses, to help obtain the updated data and identify the rejected items 252 to ensure the rejected items 252 are processed properly at the manual loading area 236 and not sent back to the automated loading area 224.

In some embodiments, the automated loading area 224 further includes a scale 258 configured to weigh the target item 218, where the scale 258 may be positioned to receive the target items 218 from the discharge conveyor 222. In other embodiments, the scale 258 may be positioned anywhere prior to the automated loading device 226. The weight measurement may be used to determine whether the target item 218 is appropriate for automated loading onto the loading container 228, whether it should be rejected and sent back to the primary conveyor 210, or whether it should be temporarily stored at the storage conveyor 256 for subsequent loading. For example, if the item 218 is relatively heavy (e.g., the item weight exceeds a threshold weight parameter), it may be rejected and sent to the primary conveyor 210 or instead temporarily diverted to the storage conveyor 256 to await a new loading container 228 to ensure the heavy item is placed at the bottom of a new loading container 228 once it becomes available to avoid damaging other items 218 already on the loading container 228. In some embodiments, the determination of whether to load the target item 218 based on its weight may also take into account the capacity status of the loading container 228 as determined via the image sensor 234. For example, heavier items may not be loaded onto the loading container 228 once a certain capacity threshold has been met. In some embodiments, the weight threshold for loading items 218 may change (e.g., it may decrease) as the loading container 228 capacity decreases (e.g., it becomes fuller) to ensure heavy items 218 are not stacked atop lighter ones. In some embodiments, the above-referenced determinations may be stored in the loading algorithm that then generates the loading instructions for the automated loading device 226.

In some embodiments, the storage conveyor 256 may be in communication with the return conveyor 254 such that the discharge system 220 pushes items onto the return conveyor 254 initially, which in turn uses a sorting device (not shown) to push the item onto the storage conveyor 256. In other embodiments, the storage conveyor 256 is a standalone conveyor untethered to the return conveyor 254 and configured to directly receive items diverted by the discharge system 220. The storage conveyor 256 may be configured to return items directly back to the automated loading device 230 for loading, and/or the storage conveyor 256 may be in communication with the discharge conveyor 222 to transport items toward the automated loading device 230 in a similar fashion as described previously.

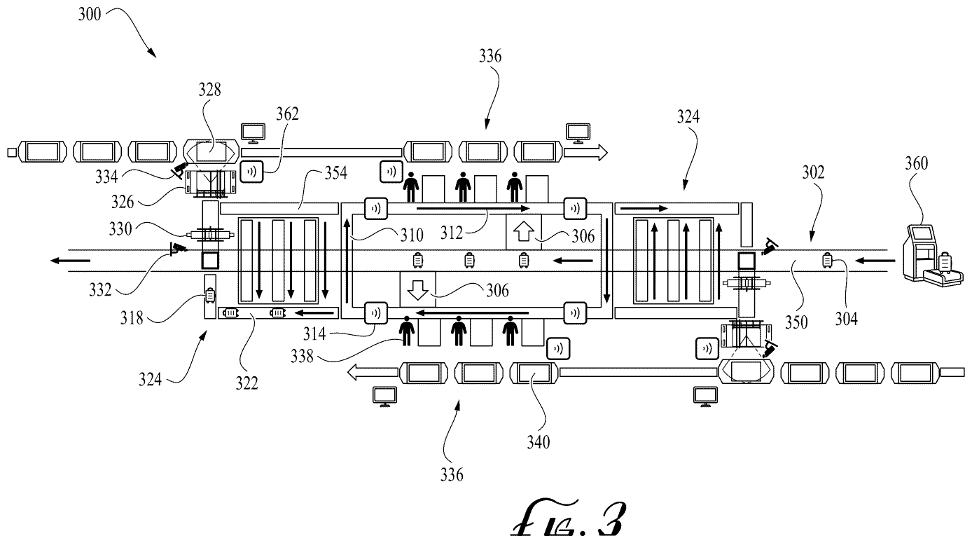

FIG. 3 is a schematic diagram of another example embodiment of an item-handling system 300 for sorting one or more items 304 transported on a conveyor system 302. With reference to FIG. 3, the item-handling system 300 may include some of the same or similar elements arranged and operating in the same or similar fashion as previously described with respect to the item-handling systems 100, 200 of FIGS. 1-2. Accordingly, some features of the item-handling system 300 may be described briefly or otherwise omitted in the following description to avoid obscuring more pertinent features of the embodiment with the understanding that features described with reference to item-handling systems 100, 200 of FIGS. 1-2 may also apply to item-handling system 300 of FIG. 3.

With reference to FIG. 3, item-handling system 300 is designed and arranged such that item information (e.g., baggage size, dimensions, type, weight, priority status, etc.) is all obtained prior to the items 304 being placed onto and transported by the conveyor system 302 for sorting. Accordingly, item-handling system 300 has no need for sensors or other devices to determine where to position corresponding items 304 while they travel along the conveying system 302. For example, in one embodiment, the item-handling system 300 may include one or more self-bag drop (SBD) station 360 designed to receive, process, and tag items 304 prior to their placement on the conveying system 302. SBD 360 acquires all suitable item information (e.g., baggage destination, size, weight, priority status, type, etc.) and links the item information to the items 304, such as via an RFID tag, optical code, or other suitable identifier. In the following description, an example using RFID tags is used, but it should be understood that other tagging mechanisms and devices may also be used, including those previously described herein, without departing from the principles of the disclosure.

After processing at SBD 360, the items 304 are loaded onto the conveyor system 302 for transport toward one or more first (automated) loading areas 324 or toward one or more second (manual) loading areas 336 depending on the item information as obtained by SBD 360 and associated with the item 304. Like conveyor system 202 of FIG. 2, conveyor system 302 may include an infeed conveyor 350 that receives items 304 from SBD 360, and inlet conveyors 306 in operable communication with the infeed conveyor 350. The inlet conveyors 306 are operable to receive the one or more items 304 from the infeed conveyor 350 and transport them to a primary conveyor 310, where the items 304 move along a pathway 312.

Adjacent the primary conveyor 310, the item-handling system 300 includes one or more sensors 314 (e.g., RFID readers or other suitable device depending on the tag mechanism) operable to read the identifier (RFID) tags on the items 304 and identify target items 318 for diversion via a discharge system (not shown but similar to discharge systems 120, 220 of FIGS. 1-2) into the automated loading areas 324. Once at the automated loading areas 324, the target items 318 are processed in a substantially similar fashion as described with reference to automated loading area 224 of item-handling system 200 of FIG. 2. Briefly, the automated loading areas 324 may each include a discharge conveyor 322 that receives and transports the target item 318 toward an image sensor 332 operable for confirming the position and/or orientation of the target item 318. If needed, a centering device 330 may reorient the item 318 for proper positioning on the discharge conveyor 322. Thereafter, an automated loading device 326 may obtain and load the item onto the loading container 328. If necessary, the automated loading areas 324 may each include a return conveyor 354 for returning items back to the primary conveyor 310 as needed, such as when the loading container 328 is full as determined by an image sensor 334 (in a similar fashion as described previously), and/or one or more storage conveyors 356 for temporarily storing target items 318 at the automated loading area 324 for subsequent processing in a similar fashion as described previously with reference to FIG. 2.

In some embodiments, the image sensor 332 (or other suitable device) may monitor and confirm that the target item 318 information is correct and the target item 318 is in the appropriate area for loading onto the corresponding container 328. In other embodiments, a second sensor 362 (e.g., an RFID reader) may be positioned adjacent the loading container 328 for confirming the item information, such as via the RFID tag, and to ensure the target item 318 is being loaded into the appropriate loading container 328.

For items 304 not suitable for automated loading, the items 304 may remain on the primary conveyor 310 until they reach one of the corresponding manual loading areas 336, where the items 304 are manually loaded onto loading conveyors 340 by human workers 338. In some embodiments, the human workers 338 may check the RFID tag and/or other data such as a QR code associated with the item 304 to confirm that the item 304 is suitable for manual loading and placed in the proper loading container 340. In some embodiments, the manual loading areas 336 may include a buffer, such as a table or other suitable workspace, (not shown) to provide an area where the human workers 338 may retrieve the items 304 without needing to pull items directly from the primary conveyor 310. The buffer may also help avoid or restrict the ability of the human workers 338 to place items 304 back onto the primary conveyor 310 to avoid interfering with the spacing of the items 304 on the primary conveyor 310 and avoid potentially separating paired items 304.

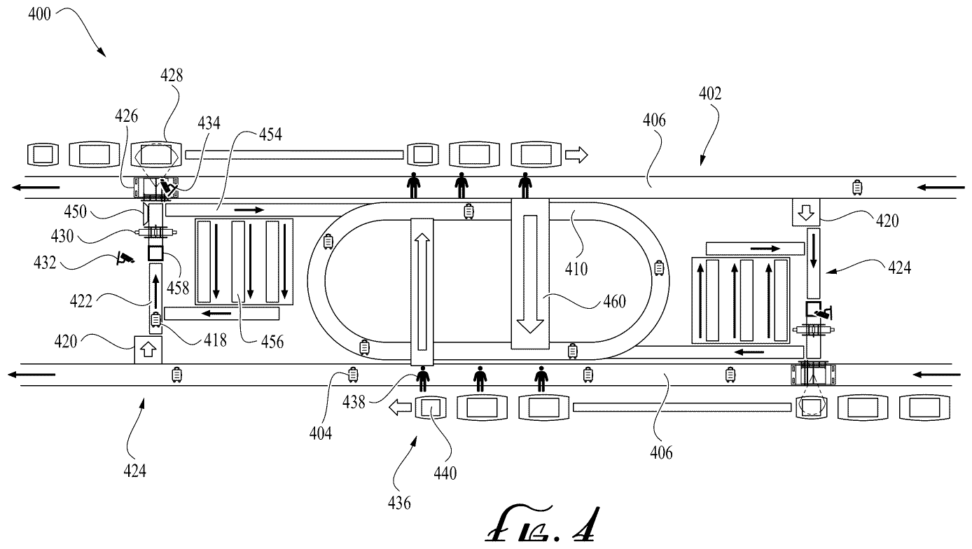

FIG. 4 is a schematic diagram of another example embodiment of an item-handling system 400 for sorting one or more items 404 transported on a conveyor system 402. With reference to FIG. 4, the item-handling system 400 may include some of the same or similar elements arranged and operating in the same or similar fashion as previously described with respect to the item-handling systems 100, 200, 300 of FIGS. 1-3. Accordingly, some features of the item-handling system 400 may be described briefly or otherwise omitted in the following description to avoid obscuring more pertinent features of the embodiment with the understanding that features described with reference to item-handling systems 100, 200, 300 of FIGS. 1-3 may also apply to item-handling system 400 of FIG. 4.

With reference to FIG. 4, item-handling system 400 is designed and arranged such that target items 418 for automated loading at a first (automated) loading area 424 and other items 404 for manual loading at a second (manual) loading area 436 are identified in advance prior to being placed onto and transported by the conveyor system 402. Accordingly, item-handling system 400 has no need for sensors or other devices to determine where to position corresponding items 404 while they travel along the conveying system 402. For example, in one embodiment, the item-handling system 400 may include a self-bag drop (SBD) station (not shown) similar to SBD 360 of FIG. 3 or other suitable pre-processing system designed to identify and tag items for automated loading or manual loading.

The item-handling system 400 includes one or more first discharge systems 420 that diverts the target items 418 directly from the inlet conveyor 406 and onto the discharge conveyor 422 at the automated loading area 424. The automated loading area 424 may include image sensors 432, 434, a scale 458, a centering device 430, an automated loading device 426, a loading container 428, a discharge system 450, return conveyors 454, and storage conveyors 456 arranged and functioning in the same or similar fashion as previously described with reference to the embodiments of FIGS. 1-3. Accordingly, those prior descriptions apply to the item-handling system 400 of FIG. 4 and are not further described herein to avoid duplication.

The item-handling system 400 also includes one or more second discharge systems 460 operable to divert the items 404 from the inlet conveyor 406 to the primary conveyor 410. As illustrated, the primary conveyor 410 may be a carousel conveyor with a closed loop pathway designed such that items 404 cannot be automatically diverted back onto the primary conveyor 410. In some embodiments, the discharged items moved onto the primary conveyor 410 are all items that were not eligible for automated loading. The discharged items may be manually loaded by human workers 438 onto loading containers 440 at the manual loading areas 436 in a similar fashion as described previously. In some embodiments, the primary conveyor 410 may also be used when automated loading is unavailable, such as due to a failure in the automated loading system or due to lack of adequate spacing between items 404 on the inlet conveyors 406.

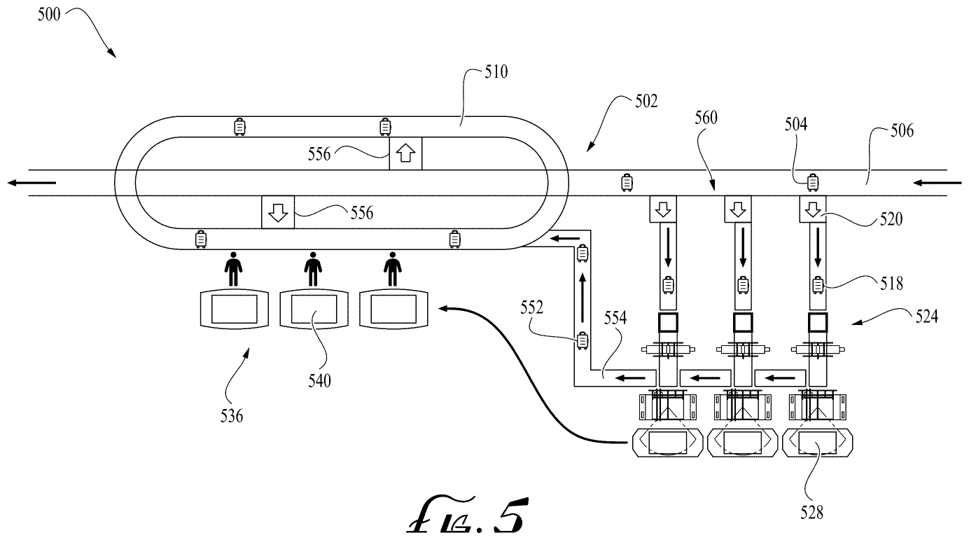

FIG. 5 is a schematic diagram of another example embodiment of an item-handling system 500 for sorting one or more items 504 transported on a conveyor system 502. With reference to FIG. 5, the item-handling system 500 may include some of the same or similar elements arranged and operating in the same or similar fashion as previously described with respect to the item-handling systems 100, 200, 300, 400 of FIGS. 1-4. Accordingly, some features of the item-handling system 500 may be described briefly or otherwise omitted in the following description to avoid obscuring more pertinent features of the embodiment with the understanding that features described with reference to item-handling systems 100, 200, 300, 400 of FIGS. 1-4 may also apply to item-handling system 500 of FIG. 5.

Item-handing system 500 includes various individual processing lines 560 at first (automated) loading areas 524, each having a dedicated discharge system 520 (similar to discharge systems 120, 220 of FIGS. 1-2) for diverting target items 518 from the inlet conveyor 506 for loading onto loading containers 528. In some embodiments, all individual processing lines 560 at the automated loading area 524 may be dedicated to a single flight so that all loading containers 528 for the diverted items 518 are loaded onto a single train (or other suitable carrier) that is then towed to the corresponding plane. In other embodiments, each processing line 560 may instead be dedicated to a different corresponding baggage destination to expedite loading of items 504 for different flights, for example. The automated loading areas 524 may each include image sensors, scales, centering devices, automated loading devices, and other components described previously with reference to the embodiments of FIGS. 1-4. In some embodiments, the item-handling system 500 may include a single return conveyor 554 that aggregates rejected items 552 received from each processing line to return the rejected item 552 back onto the primary conveyor 510.

In some embodiments, the item-handling system 500 may include additional discharge systems 556 that divert items 504 from the inlet conveyor 506 onto the primary conveyor 510. From the primary conveyor 510, items 504 may be manually loading onto loading containers 540 at a second (manual) loading area 536.

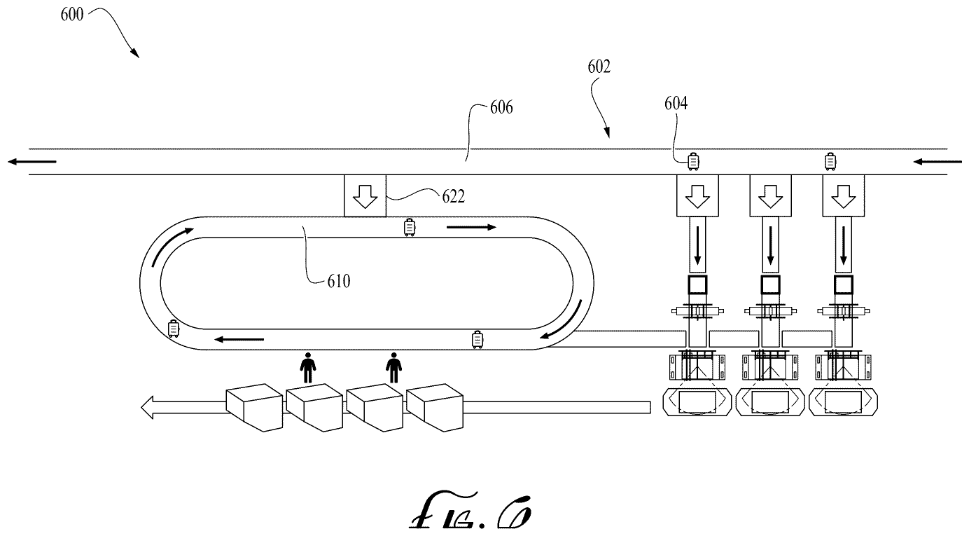

FIG. 6 is a schematic diagram of another example embodiment of an item-handling system 600 for sorting one or more items 604 transported on a conveyor system 602. With reference to FIG. 6, the item-handling system 600 may include some of the same or similar elements arranged and operating in the same or similar fashion as previously described with respect to the item-handling systems 500 of FIG. 5. With reference to FIG. 6, the item-handling system 600 may be substantially similar to item-handling system 500, except in that item-handling system 600 includes a single additional discharge system 622 that diverts items 604 from the inlet conveyor 606 onto the primary conveyor 610.

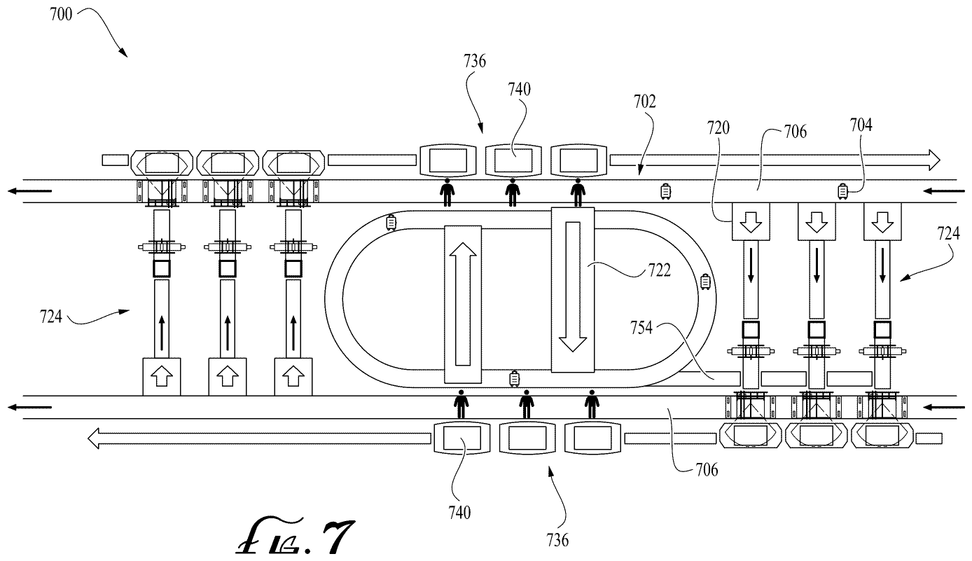

FIG. 7 is a schematic diagram of another example embodiment of an item-handling system 700 for sorting one or more items 704 transported on a conveyor system 702. With reference to FIG. 7, the item-handling system 700 may include some of the same or similar elements arranged and operating in the same or similar fashion as previously described with respect to the item-handling systems 500 of FIG. 5. With reference to FIG. 7, the item-handling system 700 may be substantially similar to item-handling system 500, except in that item-handling system 700 includes multiple, distinct first (automated) loading areas 724, each having individual discharge systems 720 (similar to discharge systems 120, 220 of FIGS. 1-2) that divert items 704 from the inlet conveyors 706 for automated loading, and also includes discharge systems 722 that divert items 704 from the inlet conveyors 706 toward multiple separate second (manual) loading areas 736 for manually loading items onto loading containers 740 as needed. In some embodiments, one of the automated loading areas 724 may include a return conveyor 754 (as shown in FIG. 5) while the other automated loading areas 724 may not.

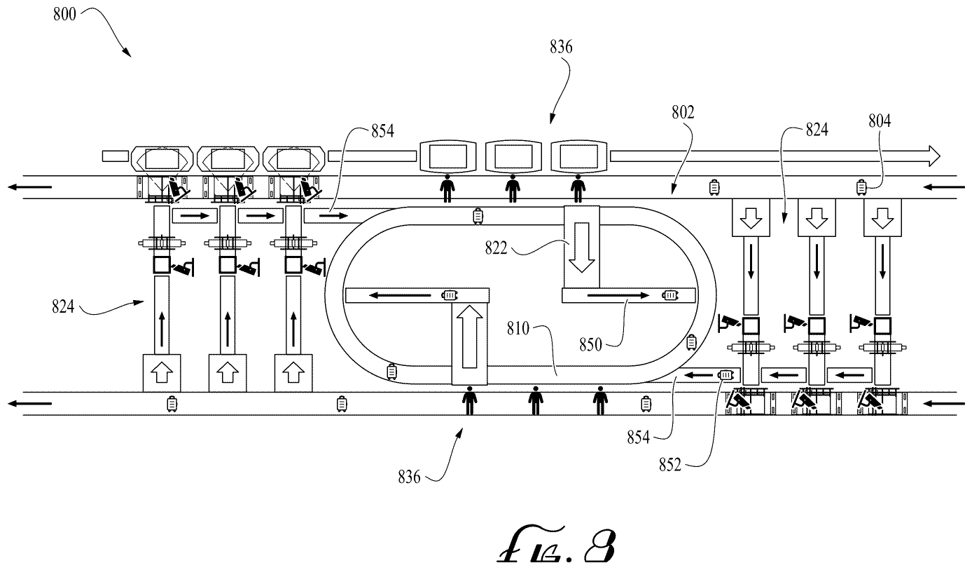

FIG. 8 is a schematic diagram of another example embodiment of an item-handling system 800 for sorting one or more items 804 transported on a conveyor system 802. With reference to FIG. 8, the item-handling system 800 may include some of the same or similar elements arranged and operating in the same or similar fashion as previously described with respect to the item-handling systems 500, 700 of FIGS. 5 and 7, respectively. With reference to FIG. 8, the item-handling system 800 may be substantially similar to item-handling system 700, except in that item-handling system 800 includes multiple, distinct first (automated) loading areas 824 and multiple, distinct second (manual) loading areas 836, where each automated loading area 824 includes a return conveyor 854 for returning rejected items 852 back onto the primary conveyor 810. In addition, the item-handling system 800 includes supply conveyors 850 that receive items from the discharge systems 822, where the supply conveyors 850 transport the items 804 back onto the primary conveyor 810. In some embodiments, the supply conveyors 850 may be independently controlled relative to one another and/or the primary conveyor 810 to help adjust spacing between items 804 as needed.

In the embodiments described with reference to FIGS. 1-8, each item is tagged and placed on the corresponding conveying systems for movement therewith and subsequent processing. In other embodiments, each item may instead be placed on a bin, tray, or other suitable conveying element and transported on the conveying system. In such embodiments, the bin, tray, or other suitable conveying element may be tagged with information associated with the item being transported thereon instead of (or in addition to) tagging the item directly. The bin, tray, or other suitable conveying element may be tagged with a QR code, optical code, RFID tag, or other suitable tag identifier. As the item moves along the conveying system, the item information may be obtained via the various sensors and readers directly from the bin, tray, or other suitable conveying element. In some embodiments, this configuration may help ensure that the tag information for the associated item is in a consistent position on the bin, tray, or other suitable conveying element to improve overall performance of the item-handling system. In some embodiments, different color trays may be used to help distinguish between items directed for automated loading and those directed for manual loading.

The example systems and methods of operation described herein provide various configurations for item-handling systems. It is to be appreciated that any one of the above embodiments or components described therein may be combined with one or more other embodiments and/or components without departing from the principles of the disclosed subject matter. In addition, it should be understood that components described herein may be separated and/or functions may be performed amongst separate devices or device portions in accordance with the present systems, devices and methods.

The item-handling systems described herein may be used for handling baggage such as in an airport setting in some embodiments. In other embodiments, the item-handling systems described herein may be used to process, sort, and load items in different environments, such as packages or parcels in a warehouse or other items in a manufacturing facility, or the like.

Finally, the above discussion is intended to be merely illustrative of the present devices, apparatuses, systems, and methods and should not be construed as limiting the appended claims to any particular embodiment or group of embodiments. Thus, while the present disclosure has been described in particular detail with reference to exemplary embodiments, it should also be appreciated that numerous modifications and alternative embodiments may be practiced without departing from the broader and intended spirit and scope of the present disclosure as set forth in the claims that follow. Accordingly, the specification and drawings are to be regarded in an illustrative manner and are not intended to limit the scope of the appended claims.

What is claimed is:

1. An item-handling system comprising:
a conveyor system configured to receive and transport one or more items thereon;
a sensor operable to obtain item information from each item of the one or more items transported on the conveyor system;
a controller in communication with the sensor, the controller configured to receive the item information from the sensor, wherein based on the item information, the controller is operable to process the item information and identify a target item from the one or more items;
a discharge system in communication with the controller, wherein based on the item information, the discharge system diverts the target item from the conveyor system to a discharge conveyor at a first loading area, while allowing untargeted items of the one or more items to bypass the first loading area and reach a second loading area;
an automated loading device disposed at the first loading area, the automated loading device operable to obtain the target item from the discharge conveyor, the automated loading device operating in conjunction with loading instructions from a loading algorithm; and
a loading container, wherein the automated loading device is further operable to load the target item onto the loading container based on the loading instructions.

2. The item-handling system of claim 1, wherein each item of the one or more items includes a unique optical code associated therewith, the optical code storing the item information, and wherein the sensor is an optical code reader operable to capture the optical code to obtain the item information.

3. The item-handling system of claim 1, wherein each item of the one or more items includes a unique RFID tag associated therewith, the RFID tag storing the item information, and wherein the sensor is an RFID reader operable to read the RFID tag to obtain the item information.

4. The item-handling system of claim 1, wherein the sensor is an image sensor operable to capture image data of each item of the one or more items, and wherein the controller receives the image data and identifies the target item based on the image data.

5. The item-handling system of claim 4, wherein the controller is further configured to compare one or more physical characteristics of the item to a corresponding threshold parameter for each of the one or more physical characteristics, and wherein the controller identifies the target item based on the one or more physical characteristics.

6. The item-handling system of claim 1, wherein the one or more items on the conveyor system is baggage, and the item information includes one or more of a baggage destination, a baggage type, a baggage weight, a baggage size, and a baggage status.

7. The item-handling system of claim 1, wherein the discharge system includes one or more diversion arms, wherein at least one of the one or more diversion arms contacts and moves the target item from the conveyor system toward the discharge conveyor.

8. The item-handling system of claim 1, wherein the controller is further configured to generate and transmit discharge instructions to the discharge system based on the item information, the discharge instructions based on compatibility of the target item with the automated loading device and/or the loading container.

9. The item-handling system of claim 1, wherein the second loading area is a manual loading area.

10. The item-handling system of claim 9, the conveyor system including a primary conveyor configured to receive the one or more items and transport the one or more items along a closed pathway, and wherein the manual loading area is adjacent one or more points of the closed pathway.

11. The item-handling system of claim 1, further comprising an image sensor having a field-of-view overlaying at least a portion of the discharge conveyor, the image sensor operable to capture image data from the target item while the target item is on the discharge conveyor, wherein the image data captures a position and/or orientation of the target item relative to the discharge conveyor.

12. The item-handling system of claim 11, further comprising a centering device operable to reposition the target item on the discharge conveyor based on the position and/or orientation of the target item relative to the discharge conveyor as captured in the image data.

13. The item-handling system of claim 1, further comprising a scale operable to weigh the target item prior to the automated loading device obtaining the target item from the discharge conveyor.

14. The item-handling system of claim 1, further comprising an image sensor with a field-of-view overlaying at least a portion of the loading container, the image sensor operable to capture image data of the loading container, the image data capturing capacity information of the loading container.

15. The item-handling system of claim 14, wherein the loading instructions for the automated loading device are based on the capacity information of the loading container.

16. The item-handling system of claim 14, further comprising a storage conveyor and a second discharge system, wherein the second discharge system is operable to divert the target item from the discharge conveyor to the storage conveyor for storage thereon, the second discharge system diverting the target item from the discharge conveyor based on the capacity information of the loading container.

17. The item-handling system of claim 16, wherein one or more of the controller, the second discharge system, and the automated loading device is further operable to cause the storage conveyor to move the target item back onto the discharge conveyor for loading onto the loading container based on the capacity information of the loading container.

18. The item-handling system of claim 1, further comprising a second discharge system operable to divert the target item from the discharge conveyor back to the conveyor system.

19. The item-handling system of claim 18, further comprising a return conveyor in communication with the conveyor system, wherein the return conveyor receives the diverted target item from the discharge conveyor and transfers the diverted target item to the conveyor system.

20. The item-handling system of claim 1, the conveyor system further comprising:
an inlet conveyor configured to receive and transport the one or more items along an inlet pathway; and
a primary conveyor in communication with the inlet conveyor, the primary conveyor receiving the one or more items from the inlet conveyor and transporting the one or more items along a closed pathway.
